(19) United States
(12) Patent Application Publication
(10) Pub. No.: US 2021/0309476 A1
(43) Pub. Date: Oct. 7, 2021

(54) IMAGE READING DEVICE AND METHOD FOR DETERMINING ACCOMPANIMENT BY METAL OBJECT

(71) Applicant: PANASONIC INTELLECTUAL PROPERTY MANAGEMENT CO., LTD., Osaka (JP)

(72) Inventors: Hirotsugu FUSAYASU, Kyoto (JP); Ryo MATSUBARA, Osaka (JP); Hidetoshi IKEDA, Fukuoka (JP); Genki TOKUNAGA, Fukuoka (JP); Hiroshi KUSUDA, Fukuoka (JP); Terumi TSUDA, Fukuoka (JP); Takeshi MATSUMOTO, Shiga (JP)

(73) Assignee: PANASONIC INTELLECTUAL PROPERTY MANAGEMENT CO., LTD., Osaka (JP)

(21) Appl. No.: 17/352,865

(22) Filed: Jun. 21, 2021

Related U.S. Application Data
(63) Continuation of application No. 16/080,154, filed on Aug. 27, 2018, now abandoned.

(30) Foreign Application Priority Data
Mar. 10, 2016 (JP) 2016-046994
Mar. 10, 2016 (JP) 2016-047010
Mar. 10, 2016 (JP) 2016-047012

(51) Int. Cl. B65H 7/02; H04N 1/00; G03G 15/00; G03G 21/00

(52) U.S. Cl. CPC B65H 7/02; H04N 1/00; G03G 15/60; H04N 1/00689; H04N 1/00726; H04N 1/0057; G03G 15/6544; H04N 1/00782; G03G 21/00; H04N 1/00037; H04N 1/00687; G03G 2215/00286; B65H 2801/39; H04N 1/00567

(57) ABSTRACT

An image reading device includes a magnetizer that magnetizes a metal object attached to a document, a magnetism detector that is disposed on the downstream side of the magnetizer in a document transport direction from a document stacking table toward the document transport path and detects residual magnetism of the metal object, and a metal object accompaniment determination unit that determines whether or not the metal object is attached to the document based on a detection result by the magnetism detector.

### CROSS REFERENCE TO RELATED APPLICATIONS

This is a continuation of U.S. patent application Ser. No. 16/080,154, filed Aug. 27, 2018, which is a National Phase application of International Application No. PCT/JP2017/008408, filed Mar. 3, 2017, which claims priority to Japanese Patent Application No. 2016-047010, filed Mar. 10, 2016, Japanese Patent Application No. 2016-046994, filed Mar. 10, 2016, and Japanese Patent Application No. 2016-047012, filed Mar. 10, 2016. The entire disclosure of each of the above-identified documents, including the specification, drawings, and claims, is incorporated herein by reference in its entirety.

### TECHNICAL FIELD

The present disclosure relates to an image reading device and a method for determining accompaniment by a metal object.

### BACKGROUND ART

An image reading device transports the documents stacked on a document stacking table (paper feeding tray) one by one to a document transport path, reads the images formed on the documents by an image reader disposed on the document transport path, and then discharges the documents to a document discharger (paper discharging tray).

Among the documents stacked on the document stacking table of such an image reading device, there is a binding needle (staple needle) made of metal which is stapled into a plurality of documents and binds the plurality of documents. When the bundle of documents (document bundle) on which staple processing is performed is transported by the document transport path, the document itself is broken or the transport roller and the image reader disposed on the document transport path are damaged.

In order to prevent such documents or members on the transport path from being damaged, a magnetic sensor (staple detecting means) that detects the staple needle attached to the document stacked on the document stacking table is provided, and it is determined whether or not the document is stapled based on a detection result of the magnetic sensor (see, for example, PTL 1).

An object of the present disclosure is to accurately determine the presence or absence of staple processing by detecting the magnetism carried by the staple needle even in a case where an amount of magnetism of a staple needle attached to the document is small.

### CITATION LIST

### Patent Literature

PTL 1: Japanese Patent Unexamined Publication No. 10-239920

### SUMMARY OF THE INVENTION

According to the present disclosure, there is provided is an image reading device that transports a document stacked on a document stacking table to a document transport path and reads an image formed on the document, the device including a magnetizer that magnetizes a metal object attached to a document, a magnetism detector that is disposed on the downstream side of the magnetizer in a document transport direction from a document stacking table toward the document transport path and detects residual magnetism of the metal object, and a metal object accompaniment determination unit that determines whether or not the metal object is attached to the document based on a detection result by the magnetism detector.

According to the present disclosure, there is provided a method for determining accompaniment by a metal object including magnetizing a metal object attached to a document, acquiring a detection result of a magnetism detector that detects residual magnetism of the metal object, and determining whether or not the metal object is attached to the document based on the detection result of the magnetism detector.

According to the present disclosure, even in a case where an amount of magnetism of a staple needle attached to the document is small, it is possible to accurately determine the presence or absence of staple processing by detecting the magnetism carried by the staple needle.

### BRIEF DESCRIPTION OF DRAWINGS

FIG. 1 is an overall perspective view of an image reading device in the present embodiment.

FIG. 2 is a block diagram showing a functional configuration of an image reading device in the present embodiment.

FIG. 3 is a side cross-sectional view of the image reading device in the present embodiment.

FIG. 4 is an upper sectional view of the image reading device in present embodiment.

FIG. 5 is a diagram showing a configuration of a magnetizing coil in the present embodiment.

FIG. 6 is a diagram showing a magnetization curve of a magnetic material.

FIG. 7 is a diagram showing a waveform of an AC magnetizing voltage.

FIG. 8A is a diagram showing a state of detecting a metal object attached to a document.

FIG. 8B is a diagram showing a state of detecting the metal object attached to the document.

FIG. 9 is a flowchart showing a staple determination operation of the image reading device in the present embodiment.

FIG. 10A is an upper cross-sectional view of magnetism detector 84 in a case where magnetism guider 88 is not disposed.

FIG. 10B is a side cross-sectional view of magnetism detector 84 in a case where magnetism guider 88 is not disposed.

FIG. 10C is a cross-sectional view of an entire surface of magnetism detector 84 (a direction perpendicular to the paper space corresponds to a document transport direction) in a case where magnetism guider 88 is not disposed.

FIG. 10D is an upper sectional view of magnetism detector 84 in a case where magnetism guider 88 is disposed.

FIG. 10E is a side cross-sectional view of magnetism detector 84 in a case where magnetism guider 88 is disposed.

FIG. 10F is a cross-sectional view of the entire surface of magnetism detector 84 in a case where magnetism guider 88 is disposed.

FIG. 11 is a diagram showing a modification example of a configuration of a metal detector in the present embodiment.

FIG. 12 is a diagram showing a modification example of a configuration of the metal detector in the present embodiment.

FIG. 13 is a diagram showing a modification example of a configuration of the metal detector in the present embodiment.

FIG. 14 is a diagram showing a modification example of a configuration of the metal detector in the present embodiment.

FIG. 15 is a layout configuration diagram of transport system 300 and metal detector (metal object accompaniment determination device) 80 disposed therein as seen from the side in the present Embodiment 2.

FIG. 16 is a disposition configuration diagram of transport system 300 and metal detector (metal object accompaniment determination device) 80 disposed therein as seen from above in the present Embodiment 2.

FIG. 17 is a layout configuration diagram of transport system 300A and metal detector (metal object accompaniment determination device) 80 disposed therein as seen from the side in a modification example of the present Embodiment 2.

FIG. 18 is a layout configuration diagram of transport system 300A and metal detector (metal object accompaniment determination device) 80 disposed therein as seen from above in the modification example of the present Embodiment 2.

FIG. 19 is a disposition configuration diagram of transport system 300B and metal detector (metal object accompaniment determination device) 80 disposed therein as seen from the side in another modification example of the present Embodiment 2.

FIG. 20 is a disposition configuration diagram of transport system 300B and another metal detector (metal object accompaniment determination device) 80 disposed therein as seen from above in another modification example of the present Embodiment 2.

### DESCRIPTION OF EMBODIMENTS

Hereinafter, the present embodiment will be described in detail with reference to drawings.

### Embodiment 1

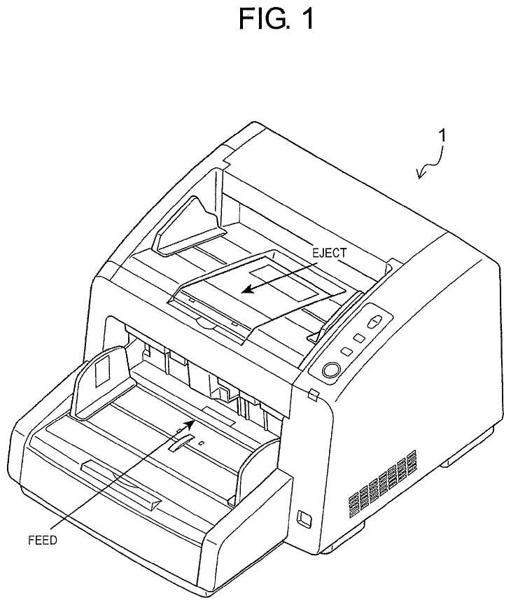

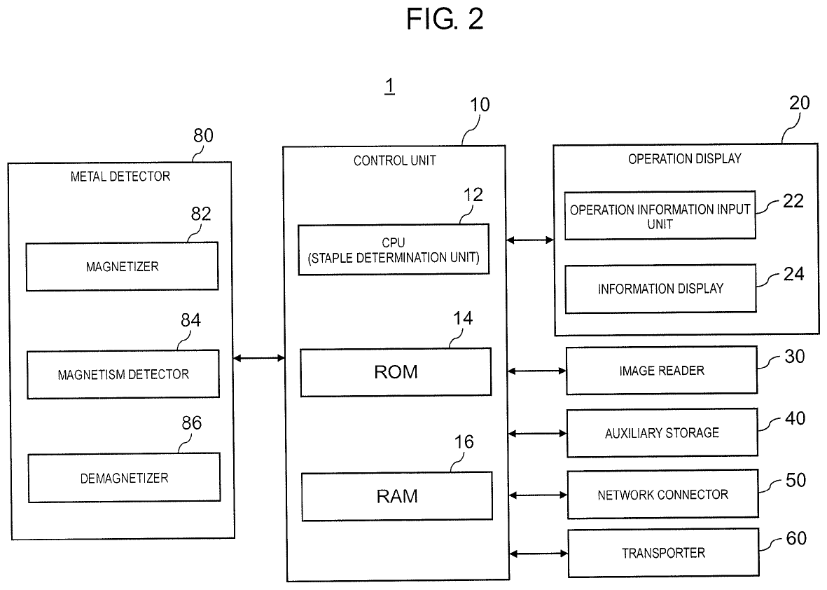

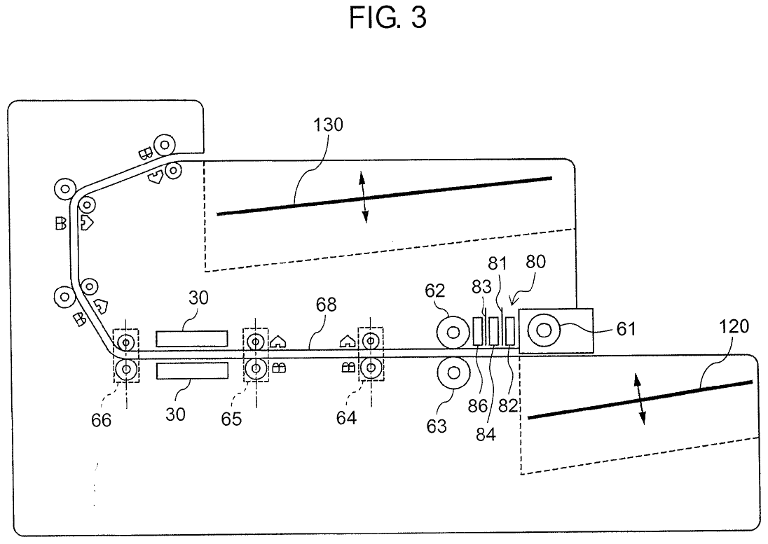

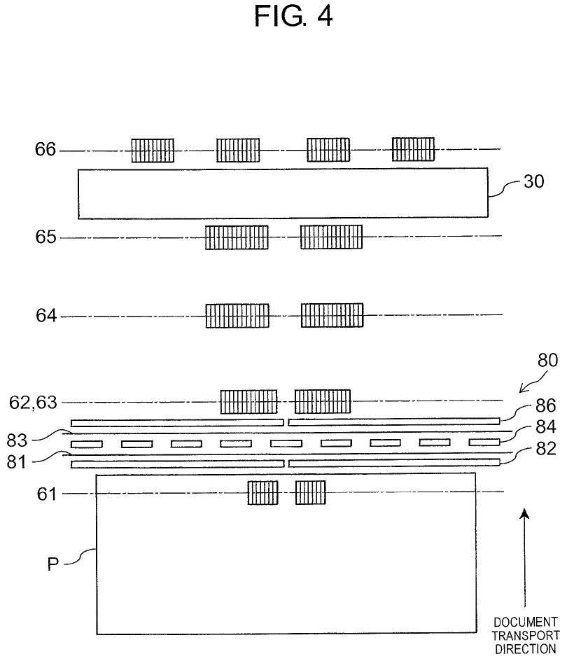

FIG. 1 is an overall perspective view of image reading device 1 as seen from the front of and above the device in the present embodiment. FIG. 2 is a block diagram showing a functional configuration of image reading device 1. FIG. 3 is a side sectional view of image reading device 1. FIG. 4 is an upper sectional view of image reading device 1.

Image reading device 1 is a document scanner, which transports (feeds) the documents stacked on document stacking table 120 one by one to document transport path 68 and discharges (ejects) the documents to document discharger 130 after reading the image formed on the documents by image reader 30 disposed on document transport path 68. Image reading device 1 may be applied to an electrophotographic image forming device.

As shown in FIG. 2, image reading device 1 includes control unit 10, operation display 20, image reader 30, auxiliary storage 40, network connector 50, transporter 60, and metal detector 80.

Control unit 10 includes central processing unit (CPU) 12 and a work memory such as read-only memory (ROM) 14 storing a control program (corresponding to the “metal object accompaniment determination program” of the present invention) and random-access memory (RAM) 16. CPU 12 reads the control program from ROM 14, develops the control program in RAM 16, and cooperates with the developed control program to centrally control the operation of each block and the like of image reading device 1. At this time, various data stored in auxiliary storage 40 is referred to. Auxiliary storage unit 40 is constituted of, for example, a nonvolatile semiconductor memory (so-called flash memory) or a hard disk drive. Control unit 10 functions as a “metal article accompaniment determination unit” and a “transport controller” of the present invention.

Control unit 10 transmits and receives various data to and from an external device (for example, a personal computer) connected to a communication network such as a local area network (LAN), a wide area network (WAN) or the like via network connector 50. Control unit 10 transmits the image read by image reader 30 to the external device (for example, a personal computer). Network connector 50 is constituted of a communication control card such as a LAN card, for example.

Image reader 30 optically reads an image formed on the document transported to document transport path 68, photoelectrically converts the image, and outputs the image as image data to control unit 10. Specifically, image reader 30 irradiates light from an exposure lamp onto the document and receives the reflected light on a light receiving surface of a solid-state imaging device such as a charge coupled device (CCD) through an imaging lens and performs photoelectric conversion. In the present embodiment, as shown in FIG. 3, image reader 30 may collectively read images formed on both sides (front and back) of the document.

Operation display 20 functions as operation information input unit 22 and information display 24. Operation information input unit 22 includes various operation keys such as ten keys and a start key, accepts various input operations by a user, and outputs operation signals to control unit 10. Information display 24 displays various operation screens, operation status of each function, and the like according to the display control signal input from control unit 10.

Conveyance unit 60 includes document transport path 68, document stacking table 120, document discharger 130, and the like. Transporter 60 includes a plurality of transport roller pairs that transport a document on document transport path 68. Document stacking table 120 and document discharger 130 are configured to move up and down according to the number of stacked documents.

As shown in FIGS. 3 and 4, on document transport path 68, paper feeding roller 61, metal detector 80, separating and retard rollers 62 and 63, first transport roller pair 64, second transport roller pair 65, image reader 30 and third transport roller pair 66 are disposed from the upstream side of the document transport direction.

The document stacked on document stacking table 120 is drawn into between separation roller 62 and retard roller 63 by paper feeding roller 61. The documents drawn in between separation roller 62 and retard roller 63 are sent out one by one and transported to first transport roller pair 64. Furthermore, the document is transported to image reader 30 at a constant speed by first and second transport roller pairs 64 and 65. In image reader 30, images formed on the front and back surfaces of the document are read. Thereafter, the document is discharged to document discharger 130 by third transport roller pair 66, the discharge roller pair, and the like. Separation roller 62 and retard roller 63 function as a “document feeder” of the present invention.

By the way, among the documents stacked on document stacking table 120 of image reading device 1, there is staple processing in which a binding needle made of metal (staple needle) is stapled into a plurality of documents to be bound and the plurality of documents are bound by the staple needle itself. Then, in the case of attempting to transport a bundle (document bundle) of such bound documents through document transport path 68, there is a problem that the document itself is broken or transport roller pairs 64, 65, and 66 disposed on document transport path 68 or image reader 30 is damaged.

Therefore, in the present embodiment, image reading device 1 is provided with metal detector 80 as staple processing detection means for detecting the staple processing applied to the documents stacked on document stacking table 120. Then, control unit 10 determines whether or not staple processing is performed on the document (whether or not a metal object is attached to the document) based on the detection result of metal detector 80. In a case where it is determined that the document is stapled, control unit 10 controls transporter 60 so as to stop the transport operation of the document.

Next, the configuration of metal detector 80 will be described. As shown in FIG. 3, metal detector 80 is disposed on the upstream side of separation roller 62 and retard roller 63 in the document transport direction and detects a metal object (for example, a staple needle) attached to document P before document P is sent out by separation roller 62 and retard roller 63.

Metal detector 80 includes magnetic shields 81 and 83, magnetizer 82, magnetism detector 84 (magnetization detector), and demagnetizer 86.

Magnetizer 82 magnetizes a metal object attached to document P from the front surface side of document P. In the present embodiment, as shown in FIG. 5, magnetizer 82 is configured by winding magnetizing coil 82B in the center portion of rectangular parallelepiped ferrite core 82A. The winding width of magnetizing coil 82B with respect to ferrite core 82A is 17 mm. The number of turns of magnetizing coil 82B with respect to ferrite core 82A is, for example, 250 turns.

Control unit 10 controls a magnetizing power supply (not shown) to apply an AC magnetizing voltage to magnetizing coil 82B. Then, a magnetizing current flows through magnetizing coil 82B, and a magnetizing magnetic field is generated toward document transport path 68. Then, by the magnetizing magnetic field generated by magnetizing coil 82B, the metal object attached to document P conveyed on document transport path 68 is magnetized.

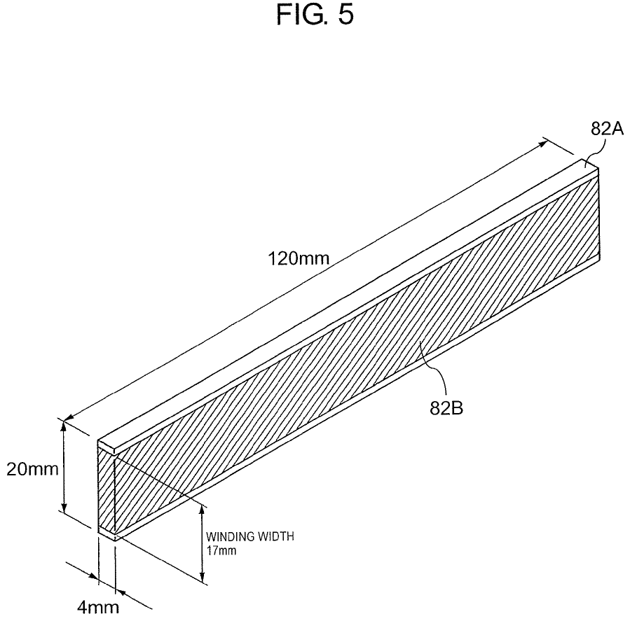

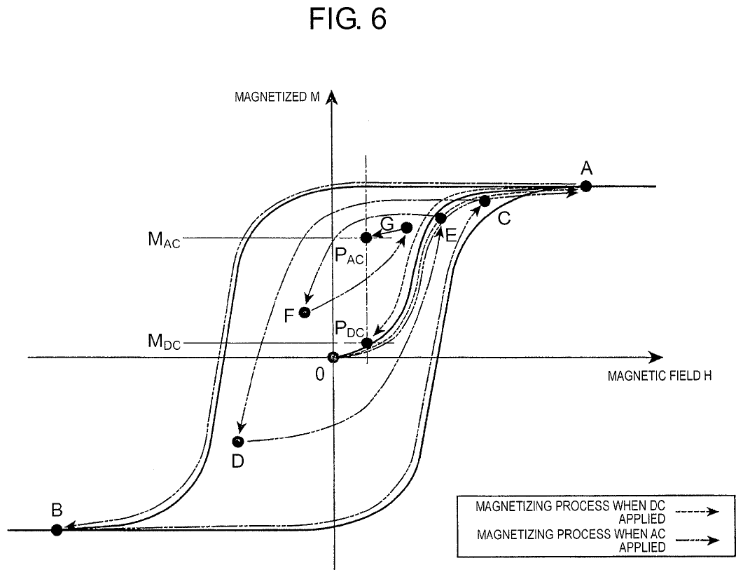

FIG. 6 is a diagram showing the magnetization curve of a magnetic material (a metal object). In FIG. 6, the horizontal axis represents the strength of a magnetic field when a magnetic material is magnetized, and the vertical axis represents the magnitude (magnetic flux density) corresponding to the magnetic field. For example, in a case where a DC magnetizing voltage is applied to magnetizing coil 82B, the magnetization curve of the magnetic material is a curve that finally reaches point PDC from point 0 through point A. In this case, the magnetization intensity (that is, residual magnetism) of the magnetic material is MDC. On the other hand, in a case where an AC magnetizing voltage is applied to magnetizing coil 82B, the magnetization curve of the magnetic material is a curve that finally reaches point PAC from point 0 via point A, point B, point C, point D, point E, point F, and point G. In this case, the magnetization intensity (that is, residual magnetism) of the magnetic material is MAC. As shown in FIG. 6, the residual magnetism of the magnetic material in a case where an AC magnetizing voltage is applied to magnetizing coil 82B is larger than that in a case where a DC magnetizing voltage is applied to magnetizing coil 82B.

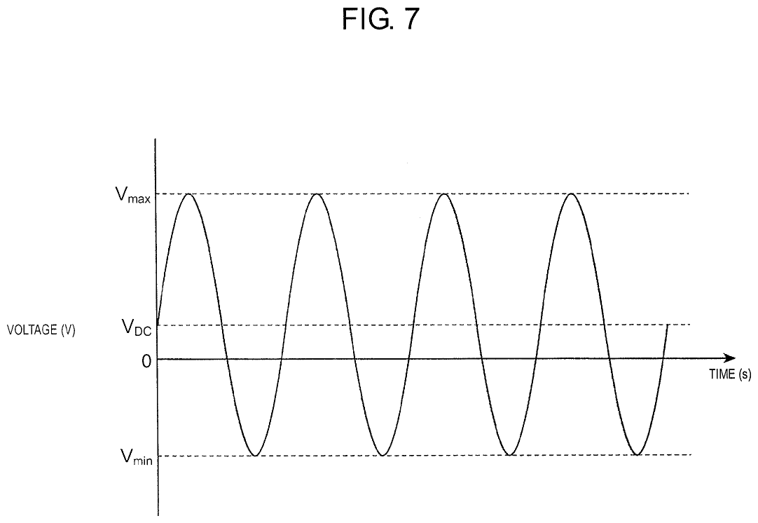

FIG. 7 is a diagram showing a waveform of an AC magnetizing voltage. As shown in FIG. 7, the AC magnetizing voltage (maximum voltage Vmax: 0.12 V, minimum voltage Vmin: −0.08 V, frequency: 200 Hz) alternately changes in magnitude and direction at constant intervals. In the example shown in FIG. 7, the magnetizing voltage includes a predetermined offset voltage (VDC: 0.02 V). Since the offset voltage is included in the magnetizing voltage, the residual magnetism of the magnetic material may be increased as compared with the case where the offset voltage is not included. Since the position of the magnetic material (for example, a staple, a clip, and the like) attached to document P to be transported moves with respect to magnetizing coil 82B, the magnitude of the magnetic field applied to the magnetic material attached to document P varies as viewed from the magnetic material. The magnetic field applied to the magnetic material becomes larger as the magnetic material approaches magnetizing coil 82B, becomes maximum in the vicinity of magnetizing coil 82B, and becomes smaller as moving away from magnetizing coil 82B. When the magnetic material is positioned in the vicinity of magnetizing coil 82B, the magnetic material is magnetized by a loop curve connecting points A and B of the magnetization curve shown in FIG. 6. As the magnetic material moves away from magnetizing coil 82B, the magnetic material is magnetized by a curve connecting points C, D, E, F, and G shown in FIG. 6, and finally point PAC becomes the residual magnetism of the magnetic material.

Magnetism detector 84 is a magnetism sensor (magnetism detection element) such as a Hall element, for example, and detects residual magnetism of a metal object magnetized by magnetizer 82. Then, magnetism detector 84 outputs the magnitude of the detected residual magnetism to control unit 10. Control unit 10 determines whether or not staple processing is performed on document P based on the magnitude (detection result) of the residual magnetism output from magnetism detector 84. For example, in a case where the magnitude of the residual magnetism output from magnetism detector 84 is equal to or larger than a predetermined value, control unit 10 determines that document P is stapled, while determining that document P is not stapled in a case where the magnitude of the residual magnetism is less than the predetermined value.

Demagnetizer 86 demagnetizes the metal object magnetized by magnetizer 82 from the front surface side of document P. Demagnetizer 86 has the same configuration as the configuration of magnetizer 82 (see FIG. 5).

Control unit 10 controls a demagnetizing power supply (not shown) to apply an AC magnetizing voltage to the demagnetizing coil. Then, a demagnetizing current flows through the demagnetizing coil, and a demagnetizing magnetic field is generated toward document transport path 68. Then, the demagnetizing magnetic field generated by the demagnetizing coil demagnetizes the metal object attached to document P transported on document transport path 68.

Magnetic shield 81 is disposed between magnetizer 82 and magnetism detector 84 in the document transport direction and prevents the influence of the magnetized electric field generated from magnetizer 82 on magnetism detector 84. That is, it is possible to improve the detection accuracy of magnetism detector 84 by using magnetic shield 81.

Magnetic shield 83 is disposed between magnetism detector 84 and demagnetizer 86 in the document transport direction and prevents the demagnetization electric field generated from demagnetizer 86 from affecting magnetism detector 84. That is, it is possible to improve the detection accuracy of magnetism detector 84 by using magnetic shield 83.

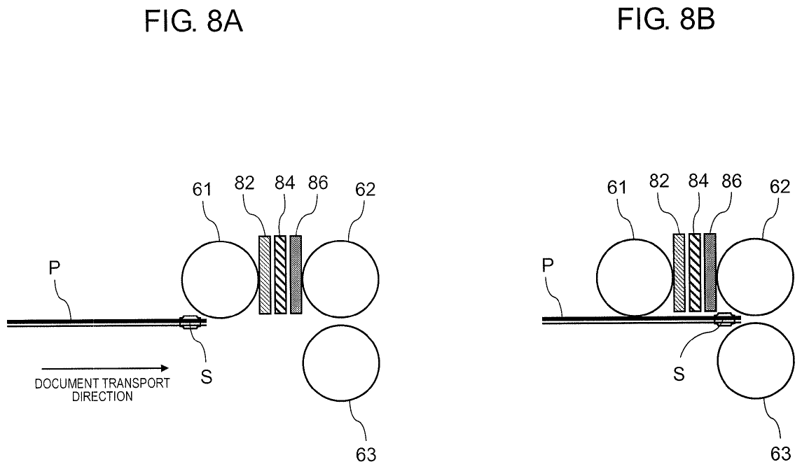

FIG. 8A shows a state before the plurality of documents P stacked on document stacking table 120 are drawn by paper feeding roller 61 in between separation roller 62 and retard roller 63. In the example shown in FIG. 8A, staple processing is performed on the front end portion of document P in the document transport direction, and staple needle S (metal object) is attached.

FIG. 8B shows a state in which staple needle S attached to the front end portion of document P is detected by metal detector 80 before document P is drawn between separation roller 62 and retard roller 63. In this case, as compared with the case where staple needle S is attached to the center portion or the rear end portion of document P in the document transport direction, it is possible to detect that a metal object is attached to document P, and finally, that staple processing is performed, and stop the transport operation of documents P before the plurality of documents P are drawn into between separation roller 62 and retard roller 63.

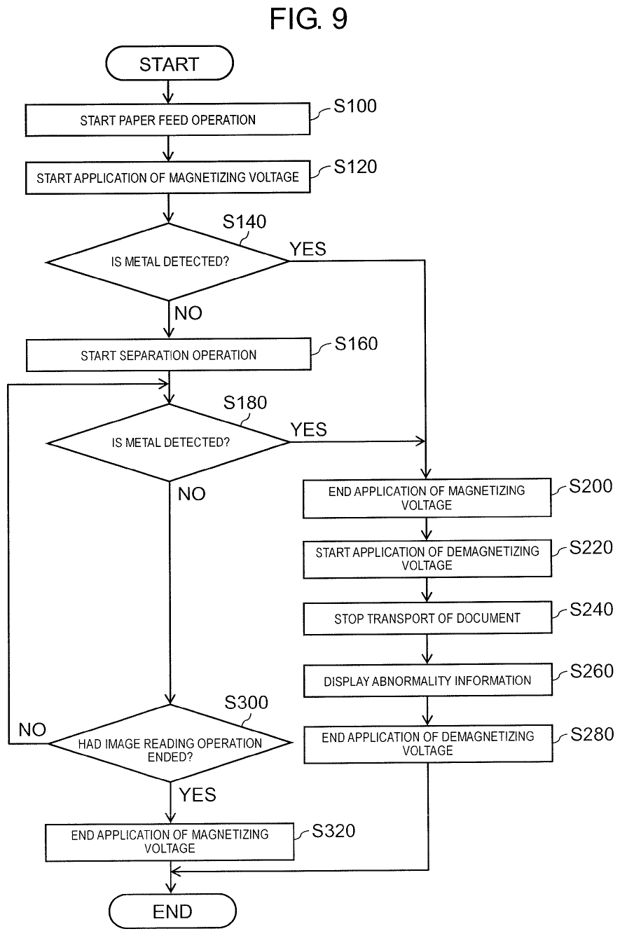

FIG. 9 is a flowchart showing a staple determination operation of image reading device 1 in the present embodiment. The processing of step S100 in FIG. 9 is started when image reading device 1 is powered on and document P is stacked on document stacking table 120.

First, control unit 10 controls transporter 60 (paper feeding roller 61) to start the paper feed operation of document P stacked on document stacking table 120 (step S100). Next, control unit 10 controls a magnetizing power supply so as to start applying a magnetizing voltage to the demagnetizing coil of demagnetizer 86 (step S120).

Next, control unit 10 acquires the detection result of magnetism detector 84 and determines whether or not a metal object (staple needle) is attached to document P, and whether or not staple processing is performed (step S140). As a result of the determination, in a case where a metal object is attached (step S140, YES), control unit 10 controls the magnetizing power supply so as to end the application of the magnetizing voltage to magnetizing coil 82B (step S200).

Next, control unit 10 controls a demagnetizing power supply so as to start applying a demagnetizing voltage to the demagnetizing coil of demagnetizer 86 (step S220). Next, control unit 10 controls transporter 60 so as to stop transporting document P (step S240).

Next, control unit 10 causes information display 24 to display abnormality information, more specifically, information indicating that staple processing is being performed on document P (step S260). Next, control unit 10 controls a demagnetizing power supply so as to start applying a demagnetizing voltage to the demagnetizing coil of demagnetizer 86 (step S280). Upon completion of the processing in step S280, image reading device 1 ends the processing in FIG. 9.

Returning to the determination of step S140, in a case where no metal object is attached (step S140, NO), control unit 10 controls transporter 60 (separation roller 62 and retard roller 63) to start the separation operation of document P drawn between separation roller 62 and retard roller 63 by paper feeding roller 61 (step S160).

Next, control unit 10 acquires the detection result of magnetism detector 84 and determines whether or not a metal object (staple needle) is attached to document P, and whether or not staple processing is performed (step S180). As a result of the determination, in a case where a metal object is attached (step S180, YES), the processing proceeds to step S200.

On the other hand, in a case where no metal object is attached (step S180, NO), control unit 10 determines whether or not the image reading operation of image reader 30 for all documents P stacked on document stacking table 120 has ended (step S300). As a result of the determination, in a case where the image reading operation has not ended (step S300, NO), the processing returns to previous step S180.

On the other hand, in a case where the image reading operation has ended (step S300, YES), control unit 10 controls the magnetizing power supply so as to end the application of the magnetizing voltage to magnetizing coil 82B (step S320). Upon completion of the processing in step S320, image reading device 1 ends the processing in FIG. 9.

As described above in detail, in the present embodiment, image reading device 1 includes magnetizer 82 that magnetizes a metal object attached to document P, magnetism detector 84 that detects residual magnetism of a metal object, and a metal object accompaniment determination unit (CPU 12) that determines whether a metal object is attached to document P or not based on a detection result of magnetism detector 84.

Magnetizer 82 forms a magnetic field in the transport path of document P. In a case where a metal object such as a staple is attached to document P, the metal object is magnetized by the magnetic field formed by magnetizer 82. Magnetic detection unit 84 detects the residual magnetism of the metal object magnetized by magnetizer 82, and the metal object accompaniment determination unit determines whether or not a metal object is attached to document P based on the detection result by magnetism detector 84.

According to the present embodiment configured as described above, even in a case where an amount of magnetism (amount of residual magnetism) carried by the metal object (staple needle) attached to document P is originally small, the residual magnetism of the metal object increases due to the magnetization operation by magnetizer 82 and it is possible to detect the residual magnetism reliably by magnetism detector 84. As a result, it is possible to determine the presence or absence of staple processing on document P accurately, and it is possible to stop the feeding operation of document P at an early stage in a case where it is determined that the staple processing is being performed on document P. Thus, it is possible to prevent the occurrence of a problem occurring in a case where document P on which staple processing is performed is transported on document transport path 68, more specifically, a problem that document P itself is broken or transport roller pairs 64 to 66 disposed on document transport path 68 or image reader 30 is damaged.

In addition, in the present embodiment, the metal object attached to document P is magnetized by applying an AC magnetizing voltage to magnetizing coil 82B. With this configuration, the residual magnetism of the metal object attached to document P becomes larger than that in a case where a DC magnetizing voltage is applied to magnetizing coil 82B, and it is possible to detect the residual magnetism more reliably by magnetism detector 84. In addition, it is possible to increase the residual magnetism of the metal object attached to document P by including the predetermined offset voltage in the AC magnetization voltage as compared with the case where the offset voltage is not included.

In addition, in the present embodiment, there is provided demagnetizer 86 that demagnetizes a metal object magnetized by magnetizer 82. With this configuration, it is possible to prevent the metal object attached to document P from adhering to a metal member disposed on document transport path 68 and it is possible to further improve the extraction efficiency of document P from document transport path 68 when it is determined that staple processing is being performed on document P when the transport operation of document P is stopped.

In the above embodiment, magnetism guider 88 (magnetic guide) that guides the residual magnetism of the metal object attached to document P toward magnetism detector 84 may be disposed in the vicinity of magnetism detector 84. For example, magnetism guider 88 has a horn shape expanding along the direction from magnetism detector 84 to document transport path 68.

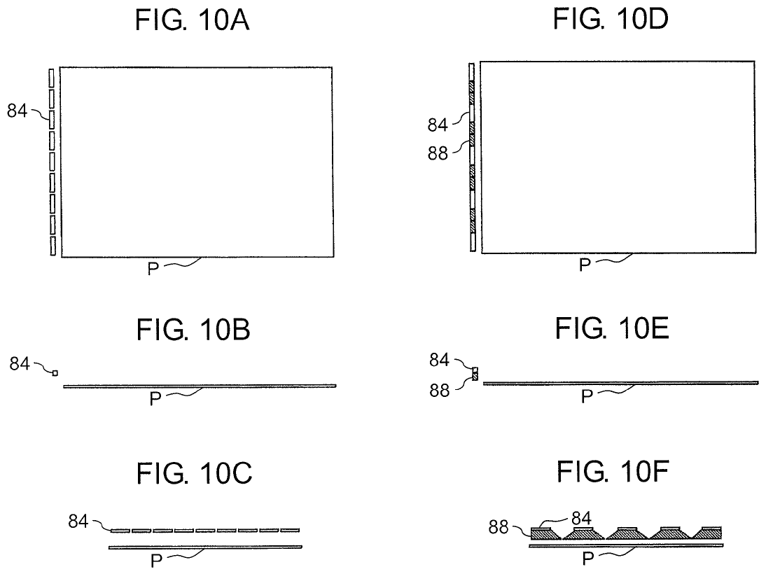

FIG. 10A is an upper cross-sectional view of magnetism detector 84 when magnetism guider 88 is not disposed. FIG. 10B is a side cross-sectional view of magnetism detector 84 in a case where magnetism guider 88 is not disposed. FIG. 10C is a cross-sectional view of an entire surface of magnetism detector 84 (a direction perpendicular to the paper space corresponds to a document transport direction) in a case where the magnetism guider 88 is not disposed. FIG. 10D is an upper sectional view of magnetism detector 84 in a case where magnetism guider 88 is disposed. FIG. 10E is a side cross-sectional view of magnetism detector 84 in a case where magnetism guider 88 is disposed. FIG. 10F is a cross-sectional view of the entire surface of magnetism detector 84 in a case where magnetism guider 88 is disposed.

As shown in FIGS. 10A to 10C, even if a metal object is attached to any position of document P in the document width direction orthogonal to the document transport direction, in order to detect the residual magnetism of the metal object by magnetizing the metal object, it is necessary to reduce a disposition interval of a plurality of magnetism detectors 84 as much as possible. On the other hand, in a case where magnetism guider 88 is disposed, as shown in FIGS. 10D to 10 F, it is possible to make a space of arranging a plurality of magnetism detectors 84 in the document width direction to some extent. Therefore, it is possible to reduce the number of magnetism detectors 84, and thus the cost, without degrading the detection accuracy of magnetism guider 88.

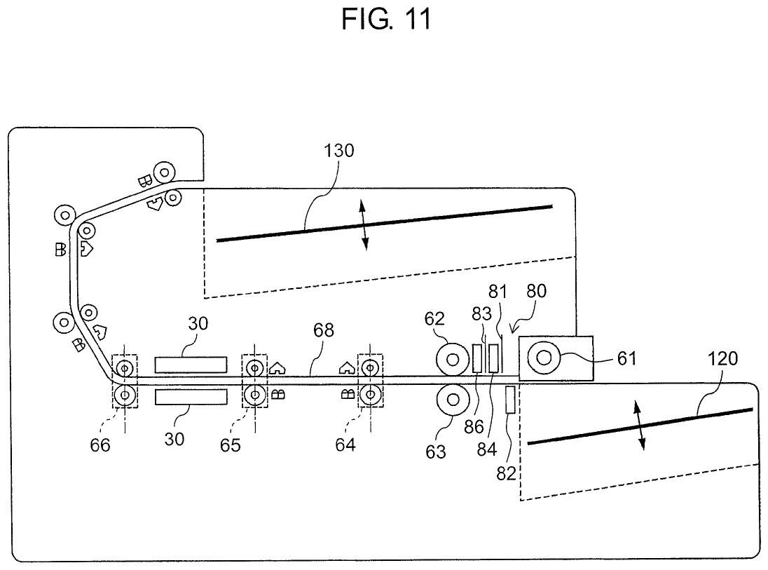

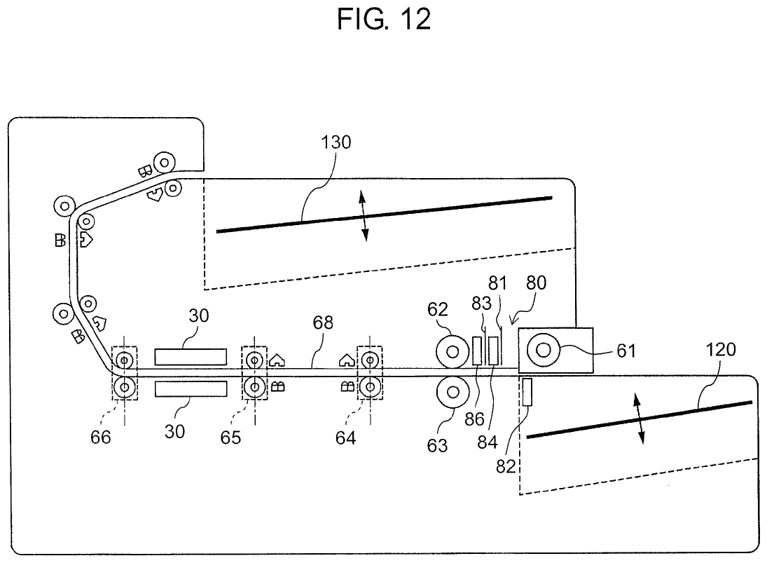

In addition, in the above embodiment, magnetizer 82 magnetizes a metal object attached to document P from the front surface side of document P, but the present invention is not limited thereto. For example, as shown in FIG. 11, magnetizer 82 may be disposed on the back surface side of document P, and a metal object attached to document P may be magnetized from the back surface side. With this configuration, it is possible to lengthen the distance between magnetizer 82 and magnetism detector 84 by the distance through document transport path 68 and further prevent the influence of the magnetized electric field generated from magnetizer 82 on magnetism detector 84. In addition, from the viewpoint of further lengthening the distance between magnetizer 82 and magnetism detector 84, as shown in FIG. 12, magnetizer 82 may be disposed on the back surface side of document P below paper feeding roller 61.

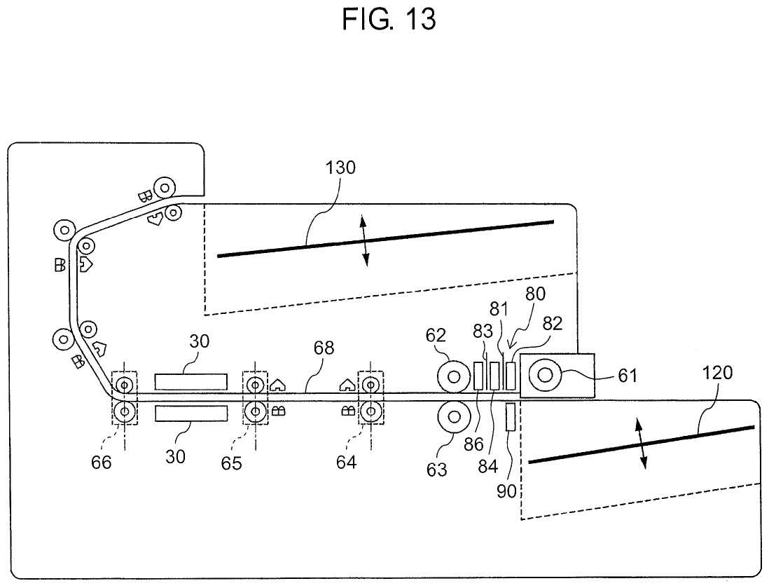

In addition, from the viewpoint of increasing the residual magnetism of the metal object attached to document P, as shown in FIG. 13, magnetizers 82 and 90 may be disposed on the front surface side and the back surface side of document P, respectively and the metal object attached to document P may be magnetized from the front surface side and the back surface side of document P.

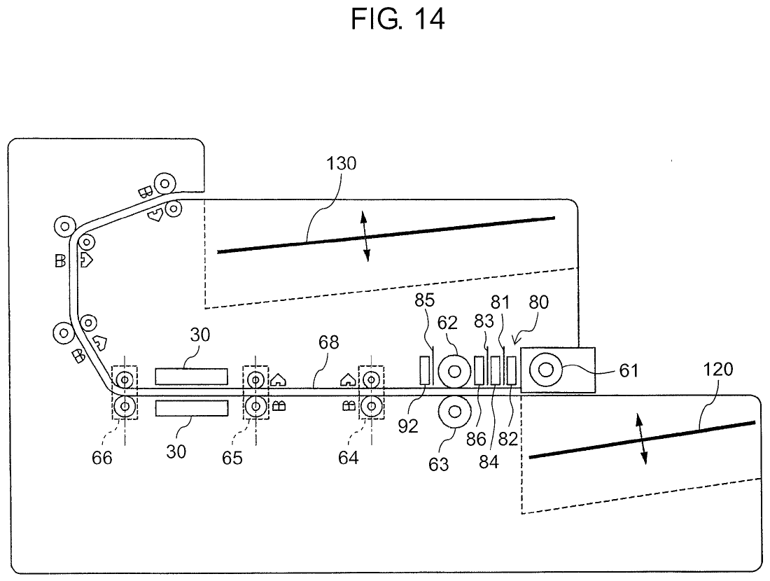

In addition, in the above embodiment, an example where demagnetizer 86 is disposed on the upstream side of separation roller 62 and retard roller 63 in the document transport direction is described, but the present invention is not limited thereto. For example, demagnetizer 86 may be disposed on the downstream side of separation roller 62 and retard roller 63 in the document transport direction. In addition, as shown in FIG. 14, demagnetizers 86 and 92 may be disposed on the upstream side and the downstream side of separation roller 62 and retard roller 63 in the document transport direction, respectively. With this configuration, when it is determined that the stable processing is being performed on document P and the transport operation of document P is to be stopped, even in a case where document P passes between separation roller 62 and retard roller 63 and the demagnetizing operation by demagnetizer 86 is not made in time, it is possible to reliably demagnetize the metal object attached to document P by demagnetizer 92.

In addition, in the above-described embodiment, a staple needle is taken as an example of a metal object accompanying document P for description, but even in a case where a plurality of documents are bound by, for example, a clip in place of a staple needle, it is possible to detect the clip as a metal object attached to document P in the same manner as the staple needle.

### Embodiment 2

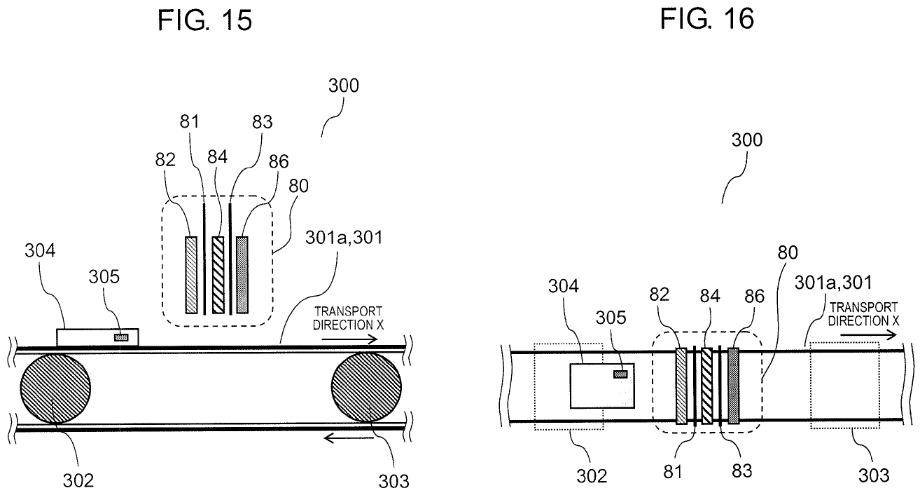

FIG. 15 is a layout configuration diagram of transport system 300 and metal detector (metal object accompaniment determination device) 80 disposed therein as seen from the side in the present Embodiment 2. FIG. 16 is a disposition configuration diagram of transport system 300 and metal detector (metal object accompaniment determination device) 80 disposed therein as seen from above in the present Embodiment 2.

As with Embodiment 1, the configuration of metal detector 80 includes magnetizer 82, magnetism detector 84, and demagnetizer 86. Magnetic shields 81 and 83 may be provided between magnetizer 82 and magnetism detector 84 and between magnetism detector 84 and demagnetizer 86, respectively. The detailed description of each unit is the same as in Embodiment 1.

In transport system 300 disclosed in the present Embodiment 2, metal detector 80 is disposed between upstream transport roller 302 located above transport surface 301a of belt conveyor 301 and on the upstream side in an article transport direction X of the transport path and downstream transport roller 303 located downstream thereof. Metal detector 80 may be disposed on the back side of transport surface 301a of belt conveyor 301.

If any metal is contained in nonmetal detection target 304 disposed on transport surface 301a which is the upper surface of the transport path, it is possible to detect the metal by metal detector 80.

For example, in a case where detection target 304 is a final product of processed food such as hamburger or a molded product in the course of processing, metal pieces due to breakage of parts of manufacturing equipment or metal screws dropped out of the manufacturing equipment due to looseness may be mixed into the food being manufactured as mixed metal 305 in the course of the manufacturing. In addition, for example, in a food dealer such as a supermarket, a sharp metal object such as a needle may be intentionally mixed in a food displayed on a product shelf.

If metal detector 80 of the present Embodiment 2 is used, mixed metal 305 mixed in the food being manufactured is magnetized by magnetizer 82, and mixed metal 305 is detected by magnetism detector 84. Then, after the magnetism detection is performed, mixed metal 305 is demagnetized by demagnetizer 86. As a result, stagnation of detection target 304 (food in this case) mixed with mixed metal 305 in the vicinity of other metal components on the transport path of belt conveyor 301 is reduced.

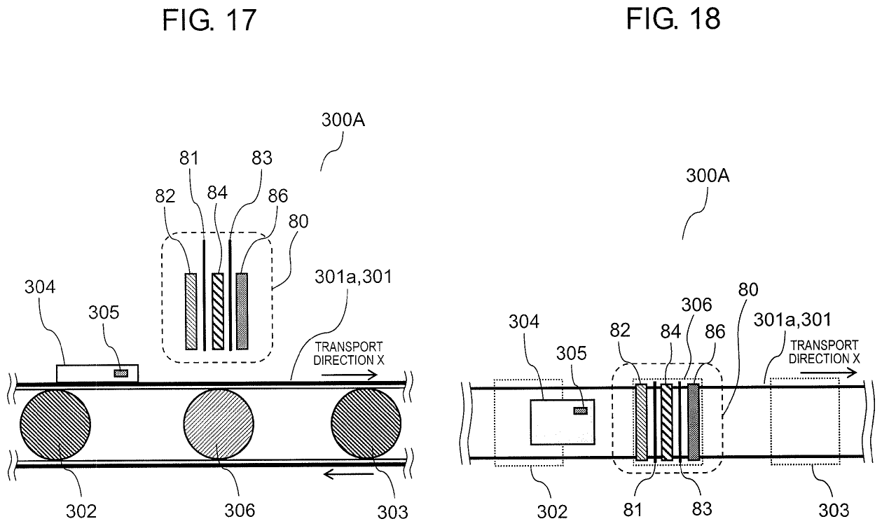

FIG. 17 is a layout configuration diagram of transport system 300A and metal detector (metal object accompaniment determination device) 80 disposed therein as seen from the side in a modification example of the present Embodiment 2. FIG. 18 is a layout configuration diagram of transport system 300A and metal detector (metal object accompaniment determination device) 80 disposed therein as seen from above in the modification example of the present Embodiment 2.

The difference between transport system 300A shown in FIGS. 17 and 18 and transport system 300 shown in FIGS. 15 and 18 is that intermediate roller 306 is disposed between upstream transport roller 302 and downstream transport roller 303 below metal detector 80. Intermediate roller 306 is made of a nonmetallic material such as plastic, for example. As a result, detection target 304 is transported more stably without lowering the detection performance of mixed metal 305 detected by metal detector 80.

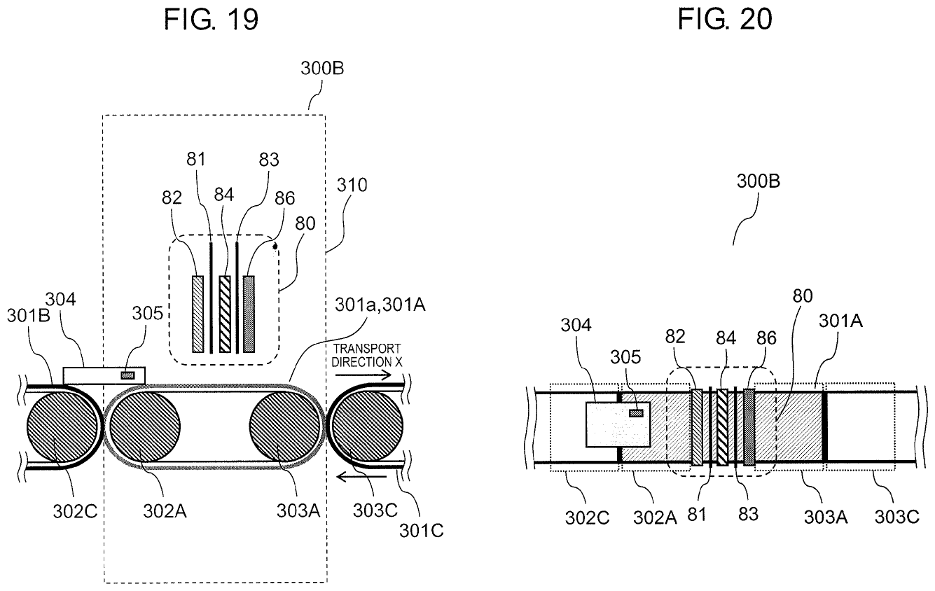

FIG. 19 is a disposition configuration diagram of transport system 300B and metal detector (metal object accompaniment determination device) 80 disposed therein as seen from the side in another modification example of the present Embodiment 2. FIG. 20 is a disposition configuration diagram of transport system 300B and another metal detector (metal object accompaniment determination device) 80 disposed therein as seen from above in another modification example of the present Embodiment 2.

Differences between transport system 300B shown in FIGS. 19 and 20 and transport system 300 shown in FIGS. 15 and 18 are described below. First, magnetizing belt conveyor 301A, upstream magnetizing transport roller 302A and downstream magnetizing transporting roller 303A are independently disposed between other upstream belt conveyor 301B and downstream belt conveyor 301C. Magnetizing belt conveyor 301A, upstream magnetizing transport roller 302A, downstream magnetizing transporting roller 303A, and metal detector 80 are integrally configured as magnetizing belt conveyor system 310.

Also in such magnetizing belt conveyor system 310, metal detector 80 is disposed between upstream transport roller 302A located above transport surface 301a of magnetizing belt conveyor 301A and on the upstream side in an article transport direction X of the transport path and downstream transport roller 303A located downstream thereof. Magnetizing belt conveyor system 310 may have an intermediate roller similar to intermediate roller 306 shown in FIGS. 17 and 18 between upstream transport roller 302 and downstream transport roller 303 below metal detector 80.

In magnetizing belt conveyor system 310 having the above-described configuration, since upstream magnetizing transport roller 302A and downstream magnetizing conveying roller 303A, and metal detector 80 are integrally formed, when a transfer line is recombined, the trouble of disassembling/assembling or readjustment of the device is reduced.

As described above, the metal object accompaniment determination system of the present Embodiment 2 includes a transport path for transporting a detection target, a magnetizer that magnetizes a metal object attached to the detection target, a magnetism detector that is disposed on the downstream side of the magnetizer in a transport direction of the transport path and detects residual magnetism of the metal object, and a metal object accompaniment determination unit that determines whether or not the metal object is attached to the detection target based on a detection result by the magnetism detector.

Magnetizer 82 forms a magnetic field in the transport path of the detection target. If a metal object such as a needle or a metal piece is mixed in the detection target, the metal object is magnetized by the magnetic field formed by magnetizer 82. Magnetism detector 84 detects the residual magnetism of the metal object magnetized by magnetizer 82, and the metal object accompaniment determination unit determines whether or not a metal object is mixed in the detection target based on the detection result by magnetism detector 84.

In the metal object accompaniment determination system of the present Embodiment 2, the transport path includes a transport belt, an upstream transport roller that is disposed on the upstream side of the transport path and rotates the transport belt so as to move the detection target placed on the transport surface of the transport belt in the transport direction, and a downstream transport roller that is disposed on the downstream side of the transport path and rotates the transport belt so as to move the detection target placed on the transport surface in the transport direction. The metal detector including the magnetizer, the magnetism detector, and the metal object accompaniment determination unit is disposed above the transport path between the upstream transport roller and the downstream transport roller. With this configuration, even if the upstream transport roller and the downstream transport roller have a component made of metal, it is possible to secure the metal detection performance by the metal detector.

In the metal object accompaniment determination system of the present Embodiment 2, the magnetizer may magnetize the metal object from at least one of the transport surface side of the transport path and the back surface side thereof.

In the metal object accompaniment determination system of the present Embodiment 2, a magnetic shield disposed between the magnetizer and the magnetism detector in the transport direction may be provided.

The metal object accompaniment determination system of the present Embodiment 2 may further include a demagnetizer that demagnetizes the metal object magnetized by the magnetizer.

In the metal object accompaniment determination system of the present Embodiment 2, the demagnetizer is disposed on the downstream side of the magnetizer in the transport direction.

In the metal object accompaniment determination system of the present Embodiment 2, a magnetic shield disposed between the magnetism detector and the demagnetizer in the transport direction may be provided.

In the metal object accompaniment determination system of the present Embodiment 2, when it is determined by the metal object accompaniment determination unit that a metal object is attached to the detection target, a transport controller that performs control to stop the transport operation of the detection target may be provided.

In the metal object accompaniment determination system of the present Embodiment 2, the magnetizer may magnetize a metal object attached to the document by applying an AC magnetizing voltage to the magnetizing coil.

In the metal object accompaniment determination system of the present Embodiment 2, the magnetizing voltage may include a predetermined offset voltage.

In the metal object accompaniment determination system of the present Embodiment 2, a magnetism guider that guides the residual magnetism of the metal object toward the magnetic detection portion may be further provided.

By using metal detector 80 provided in the metal object accompaniment determination system of the present Embodiment 2, mixed metal 305 mixed in detection target 304 is magnetized by magnetizer 82, and mixed metal 305 is detected by magnetism detector 84 and demagnetized by demagnetizer 86 after magnetism detection is performed.

Such a system for detecting a mixed metal due to magnetization may reduce the inclusion of metal into processed food shipped from a food factory by, for example, being disposed in the middle or the final process of a production line of the processed food. In addition, by arranging such a detection system, for example, in front of a checkout cash register of a supermarket, selling of metal-contaminated foods is reduced. Furthermore, such a detection system reduces the risk of injury to customers or exposure to the danger of life as a result of mistaken provision of metal-containing food to customers by being used at the stage of delivering foodstuffs at food places such as restaurants or at the stage before cooked food is offered to customers.

Each of the above-described embodiments is merely an example of a concrete implementation in carrying out the present invention, and the technical scope of the present invention should not be interpreted restrictively by these embodiments. That is, it is possible to implement the present invention in various forms without departing from the gist or the main features thereof.

### Industrial Applicability

The present disclosure is useful as an image reading device and a method for determining accompaniment by a metal object that are capable of accurately determining the presence or absence of staple processing.

### Reference Marks in the Drawings

1 IMAGE READING DEVICE

10 CONTROL UNIT

12 CPU

14 ROM

16 RAM

20 OPERATION DISPLAY

22 OPERATION INFORMATION INPUT UNIT

24 INFORMATION DISPLAY

30 IMAGE READER

40 AUXILIARY STORAGE

50 NETWORK CONNECTOR

60 TRANSPORTER

61 PAPER FEEDING ROLLER

62 SEPARATION ROLLER

63 RETARD ROLLER

64 FIRST TRANSPORT ROLLER PAIR

65 SECOND TRANSPORT ROLLER PAIR

66 THIRD TRANSPORT ROLLER PAIR

68 DOCUMENT TRANSPORT PATH

80 METAL DETECTOR

81, 83, 85 MAGNETIC SHIELD

82, 90 MAGNETIZER

82A FERRITE CORE

82B MAGNETIZING COIL

84 MAGNETISM DETECTOR

86, 92 DEMAGNETIZER

88 MAGNETISM GUIDER

120 DOCUMENT STACKING TABLE

130 DOCUMENT DISCHARGER

What is claimed is:

1. An item transport system comprising:
an upstream conveying roller and a downstream conveying roller that transport an item;
a magnetizer that magnetizes a metal object included in the item;
a magnetic detector that detects residual magnetism of the metal object; and
a metal object accompaniment determination processor that determines whether or not the metal object is included in the item based on a detection result of the magnetism detector, wherein
the magnetizer and the magnetic detector are disposed above or below the radius of the upstream conveying roller or the radius of the downstream conveying roller with respect to a vertical direction of a line connecting the rotational axis of the upstream conveying roller and the downstream conveying roller.

2. The item transport system of claim 1, further comprising:
a demagnetizer that demagnetizes the metal object magnetized by the magnetizer.

3. The item transport system of claim 1, further comprising:
a belt conveyor abutting on the upstream conveying roller and the downstream conveying roller is provided.

4. The transport system of claim 3, wherein:
the magnetizer, the magnetic detector and the metal object accompaniment determination processor are arranged above the belt conveyor abutting on the upper surface of the upstream conveying roller and the downstream conveying roller or below the belt conveyor abutting on the lower surface of the upstream conveying roller and the downstream conveying roller.

5. The transport system of claim 1, further comprising:
an intermediate roller provided between the upstream conveying roller and the downstream conveying roller.

6. The transport system of claim 5, wherein:
the magnetizer, the magnetic detector and the metal object accompaniment determination processor are arranged in the same direction as the article with respect to the intermediate roller.

7. The transport system of claim 5, wherein:
the intermediate roller is made of a non-metal.

8. A item transport device comprising:
an upstream conveying roller and a downstream conveying roller that transport an item;
magnetizer that magnetizes a metal object included in the item;
a magnetic detector that detects residual magnetism of the metal object; and
a metal object accompaniment determination processor that determines whether or not the metal object is included in the item based on a detection result of the magnetism detector, wherein
the magnetizer and the magnetic detector are disposed above or below the radius of the upstream conveying roller or the radius of the downstream conveying roller with respect to a vertical direction of a line connecting the rotational axis of the upstream conveying roller and the downstream conveying roller.

9. A transport system using the transport device of claim 8, wherein:
the transport device is disposed between another independent transport path.
